(19) United States
(12) Patent Application Publication
(10) Pub. No.: US 2003/0142819 A1
(43) Pub. Date: Jul. 31, 2003

(54) Device and method for evaluating algorithms

(76) Inventor: Marc Bellocchio, Aubagne (FR)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(21) Appl. No.: 10/312,468

(22) PCT Filed: Jun. 22, 2001
(86) PCT No.: PCT/FR01/01982

(30) Foreign Application Priority Data
Jun. 30, 2000 (FR) 00/08509

(51) Int. Cl. H04L 9/00

(52) U.S. Cl. 380/28

(57) ABSTRACT

The device (6) for the evaluation of algorithms comprises:

means (8,15) for establishing an algorithm and a specification imposed on that algorithm;

means (16) for presenting the algorithm as a concatenation of base functions, each implying at least one basic algorithmic function;

means (18) for checking parameters involved in the execution of the base functions by reference to the specification; and

means (20) for indicating an error, as the case arises, detected by the checking means.

The invention also relates to a process based on the operation of the above device. It can serve to construct and validate an algorithm without having to create an executable code beforehand.

The present invention relates to a device and method for evaluating algorithms especially, but not exclusively, in the field of data encryption.

An algorithm in the general sense is a mathematical system which carries out a finite number of operations on inputted data. Accordingly, an algorithmic calculation means can be considered as a functional unit which accepts inputted data and delivers output data corresponding to a determined set of operations performed on the inputted data.

Encryption is the technique of transforming an initially clear message into a coded message intelligible only by someone in possession of a specific encryption code. When messages are processed by electronic means, they take the form of digital data which comprise binary words representing values or instructions. In many applications, it is important to ensure that the information contained in these data remain confidential, which implies having to store and/or send that data in encrypted form.

To this end, the data to be protected are submitted to algorithmic calculation means programmed to execute an encryption algorithm. The encrypted data at the output are then handled in the vulnerable parts of a systems application, and in particular the storage areas and transmission channels. Even if the encrypted data are conceivably accessible within the system by unauthorized persons, they cannot reveal their information content without a decryption operation. Decryption is the reverse operation of encryption which enables the information in the protected data to be restituted through a decryption algorithm. The latter comprises a set of operations which are the reverse of the encryption algorithm, possibly involving the use of a decryption key, i.e. a codeword used during encryption.

An example of an application which often calls for the encryption and decryption of digital data is that of IC cards (also known as chip cards or smart cards). IC cards are now very widely used as a medium for storing confidential information (bank, commercial, medical, etc.). It is thus important to protect the information that transits through these cards against an attack either by a third party or by the user tempted to modify that information to his or her advantage.

Sensitive data of the IC card and its interfaces are classically encrypted by encryption algorithms which are becoming more and more complex. These algorithms notably involve arithmetical calculations on very long data strings, which can attain 1024 bits, or even 2196 bits.

The elaboration of these algorithms “on chip” calls upon elementary functions which must be used in a precise manner, in terms of a well-defined specification.

The creation of a cryptographic code thus passes through the following phases: specification, general design, detailed design, encoding, integration test, and validation.

The phase of testing and correcting errors noted during testing (i.e. debugging) and is long and difficult to implement. Indeed, it requires creating test programs, carrying out the tests, and subsequently correcting the source code with data which can be up to 2196 bits long.

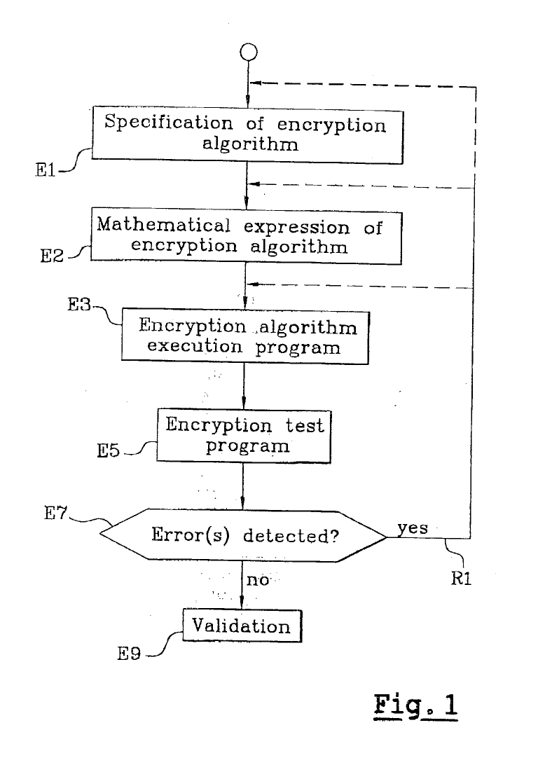

The main steps that come into play in elaborating a classical encryption program for validation according to a classical approach shall now be briefly described with reference to FIG. 1.

The first step E1 consists in elaborating the specification or list of requirements for the algorithm. This involves establishing the parameters required for the application considered: number of bits at the input, at the output, degree of security for the encryption, encryption techniques to be used, etc.

This initial specification serves as a starting point to create the mathematical expression of the encryption algorithm (step E2). This operation is carried out manually on paper, possibly with the help of a small electronic calculator, by applying or adapting algorithmic techniques that enable to meet the specification. To this end, use may be made of so-called high-level encryption functions: Rivest, Shamir and Adleman (RSA), Secure Hash Algorithm (SHA), Digital Signature Algorithm (DSA) techniques, etc. and/or low level functions: addition, subtraction, division, multiplication, . . . The result of such an operation remains in abstract form and cannot be validated in the context of an electronic system exploiting the algorithm, such as an IC card.

The next step E3 is thus to create a program for executing the encryption algorithm. In this step, the mathematical expression of the algorithm previously obtained is transcribed into a computer program which can execute the algorithm. This program is compiled in the form of source code in a low level language that shall be used by the electronic system in exploiting the algorithm. It is intended to allow the introduction of binary input data to be encrypted and to output these data encrypted by the algorithm established at step E2, or vice versa.

However, the complexity of the above-mentioned steps E1 to E3 taken as a whole is such that validation steps must be first carried out before exploiting that program.

To this end, there is established (step E5) a test program specifically adapted to the algorithm, to the program for executing the latter (execution program) and to the exploiting system. This test program supplies the execution program with input data conforming to the specification, and in accordance with a determined sequence, for evaluating as many cases as possible of the use of this algorithm.

Next, the data supplied in response to the execution program are analyzed manually to check that they correspond to the specification, whether an error has occurred, etc. (step E7).

If an error or non-conformity is detected, its causes are analyzed and the process returns to the step at the origin of the problem for attempting to correct the execution program (return loop R1). This last step, as well as all the ones that follow, must then be iterated until no error is detected.

When this condition is satisfied, the process continues with the validation of the encryption program in the form useable by the electronic exploitation system (step E9). This program can then be reproduced in the memory of the different media of the system, such as in IC cards.

It can be noted that the encryption test program is rarely a source of error, which implies that each error observed almost always requires a revision of executable code of the execution program, and often of the mathematical expression of the encryption algorithm.

This classical approach is thus laborious, costly in resources and slows down considerably the development time of new products that execute encryption or other algorithms. These disadvantages are notably due to the fact that it is necessary to produce a program for executing the algorithm and a test program for the latter before even validating the algorithm.

In view of this problem, the present invention proposes a device for the evaluation of algorithms, characterized in that it comprises:

means for entering an algorithm and a specification imposed on that algorithm;

means for presenting the algorithm as a concatenation of base functions, each implying at least one basic algorithmic function;

means for checking parameters involved in the execution of the base functions by reference to the specification; and

means for indicating an error, as the case arises, detected by the checking means.

Advantageously, the base functions present themselves in the form of respective modules, of which at least some are modules for executing low level operations (for example simple arithmetic operations). Other modules can be modules for executing higher level operations, for example Secure Hash Algorithm (SHA), or Digital Signature Algorithm (DSA) type operations, etc.

For enhanced ease of operation, the device can comprise a graphics interface allowing overall access to the functions offered.

The interface can present in graphic form input and output parameters of data relative to each base function implemented.

Preferably, the indicating means present a diagnosis of an error arising, indicating the base function(s) involved in the error.

Optionally, the device can further comprise means for creating an executable software code corresponding to a validated algorithm.

In a typical application, the algorithms pertain to encryption and/or decryption calculations.

In an embodiment, the device can be configured to operate with a hardware type of emulator, the device having a connection to an equipment emulation system, such as an integrated circuit card (smart card), and/or with a simulator, the device having a connection to an equipment simulator, such an integrated circuit card.

In a preferred embodiment, the device is functionally integrated to a PC type computer.

An object of the invention is also the use of the above device for the construction of an algorithm exploitable from a library of cryptographic base modules carried in an integrated circuit, such as an integrated circuit card (smart card).

The invention also relates to a method of evaluating algorithms comprising a step of establishing a specification for the algorithm and a step of establishing an algorithm having to conform to the specification;

characterized in that it comprises the steps of:

presenting the algorithm as a concatenation of base functions, each implying at least base algorithmic function;

checking parameters involved in the execution of the base functions by reference to the specification; and

indicating an error, as the case arises, detected during the checking step.

The different optional aspects presented above in the context of the device apply mutatis mutandis to that method.

The invention and its advantages shall appear more clearly from reading the following description of the preferred embodiments, given purely as non-limiting examples with reference to the appended drawings in which:

FIG. 1, already described, is a flow chart which summarizes the main steps in elaborating and validating an algorithm execution program according to a classical approach;

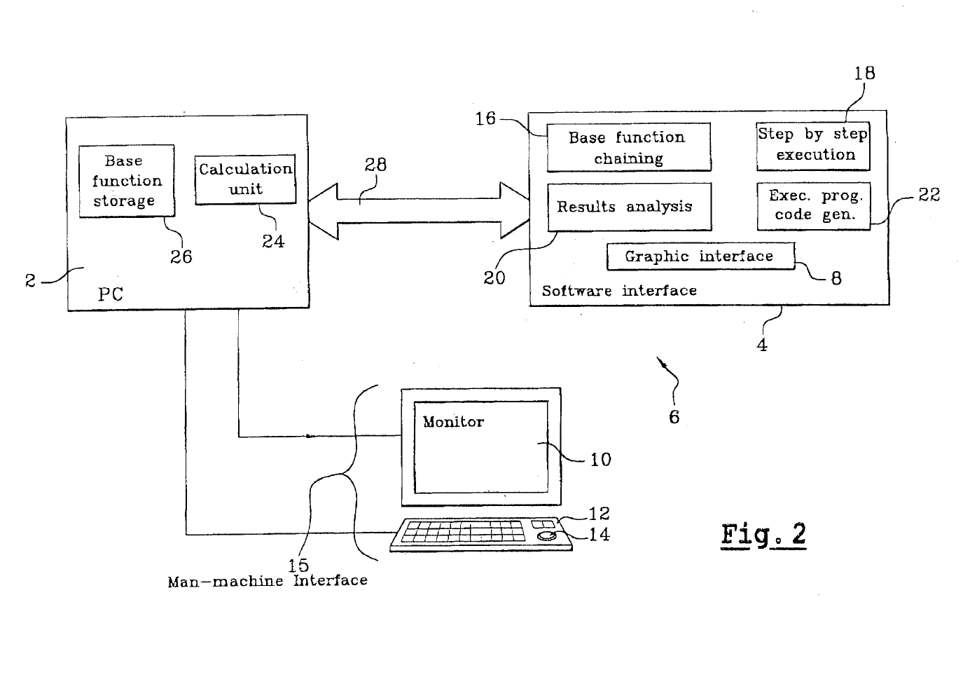

FIG. 2 is a simplified block diagram which shows symbolically functional means of a computer and a computer program which are operative in the implementation of an algorithm evaluation and development tool in accordance with the present invention;

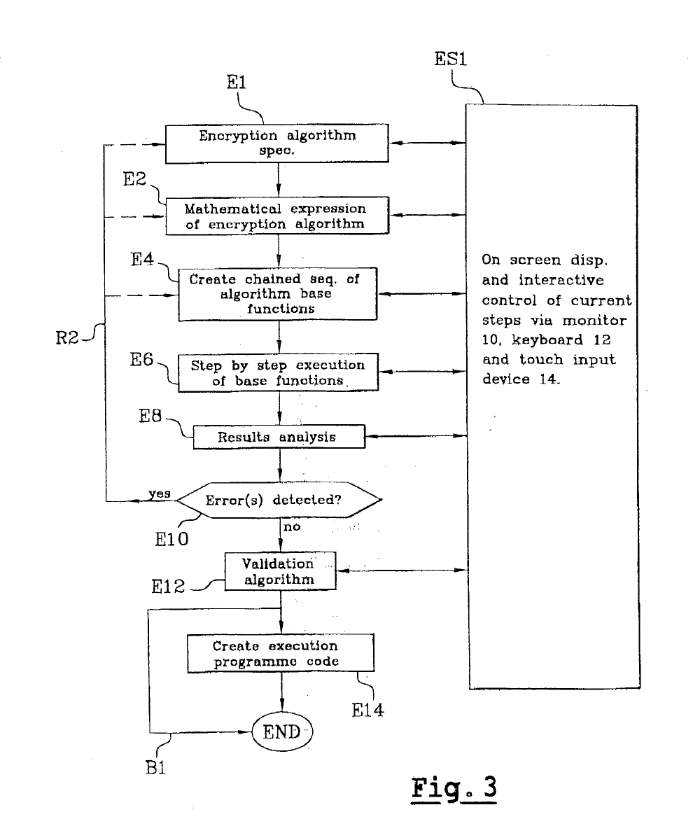

FIG. 3 is a flow chart showing the main steps involved in the elaboration and validation of an algorithm in accordance with the invention;

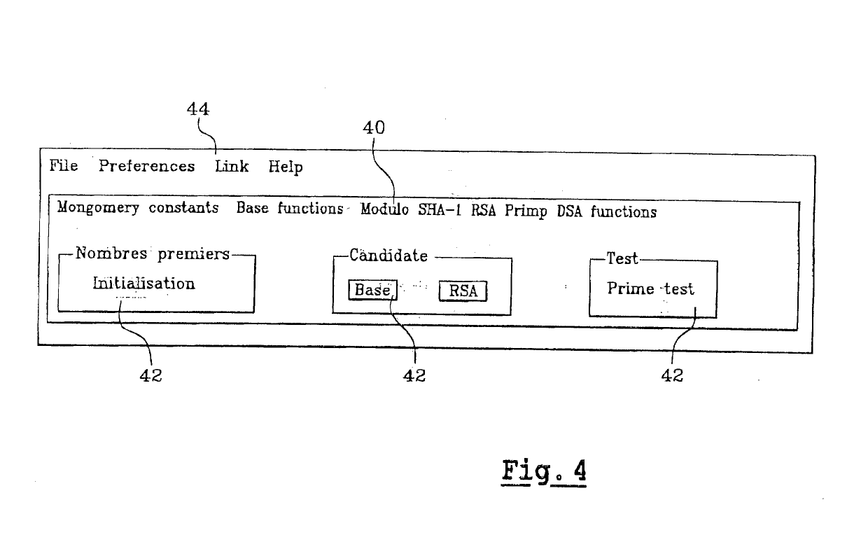

FIG. 4 shows a first interactive display page produced by a software interface of the tool of FIG. 2;

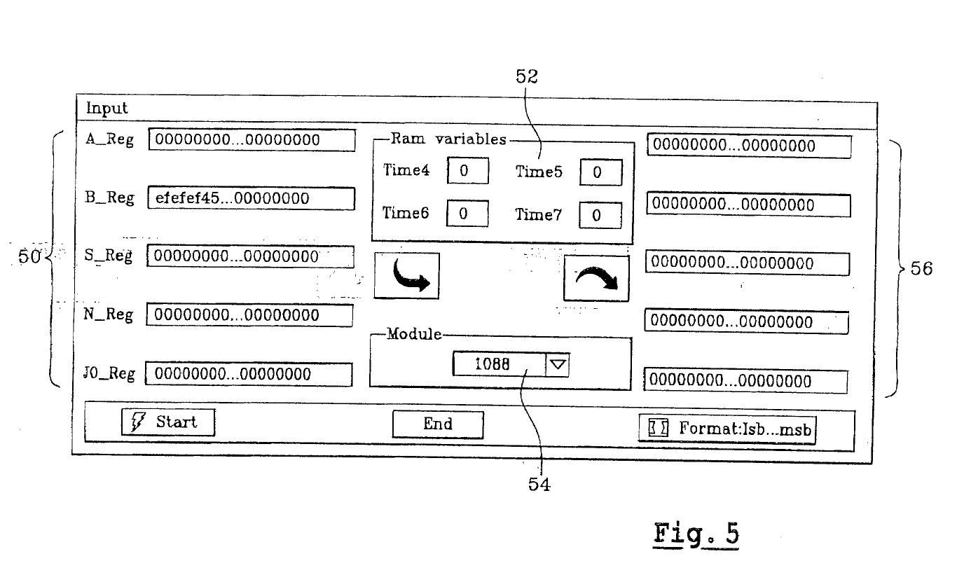

FIG. 5 shows a second interactive display page produced by a software interface of the tool of FIG. 2;

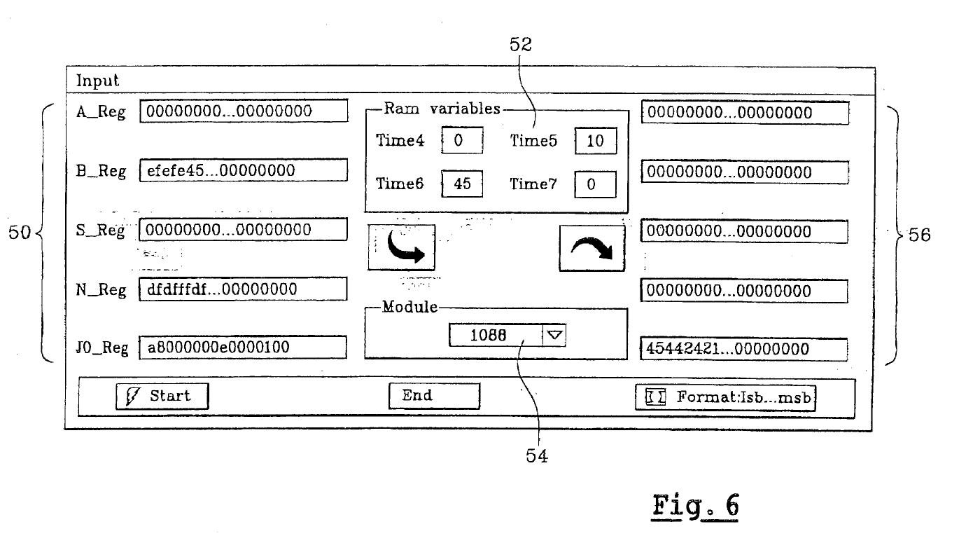

FIG. 6 shows a third interactive display page produced by a software interface of the tool of FIG. 2;

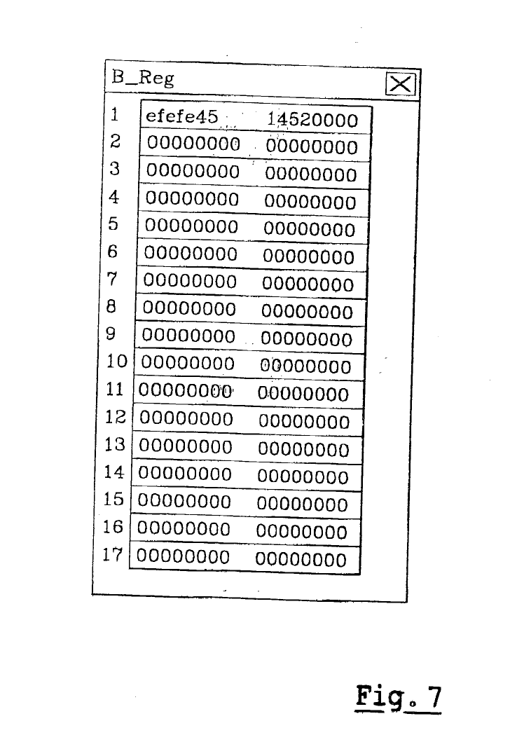

FIG. 7 shows a fourth interactive display page produced by a software interface of the tool of FIG. 2;

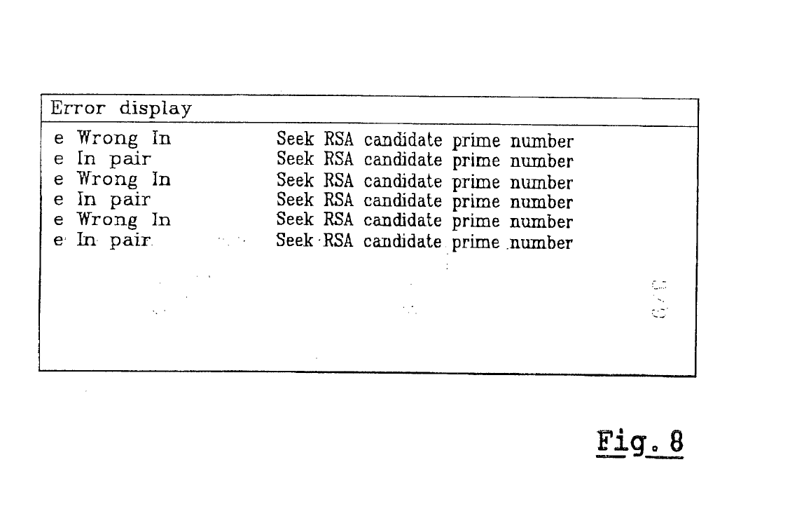

FIG. 8 shows a fifth interactive display page produced by a software interface of the tool of FIG. 2; and

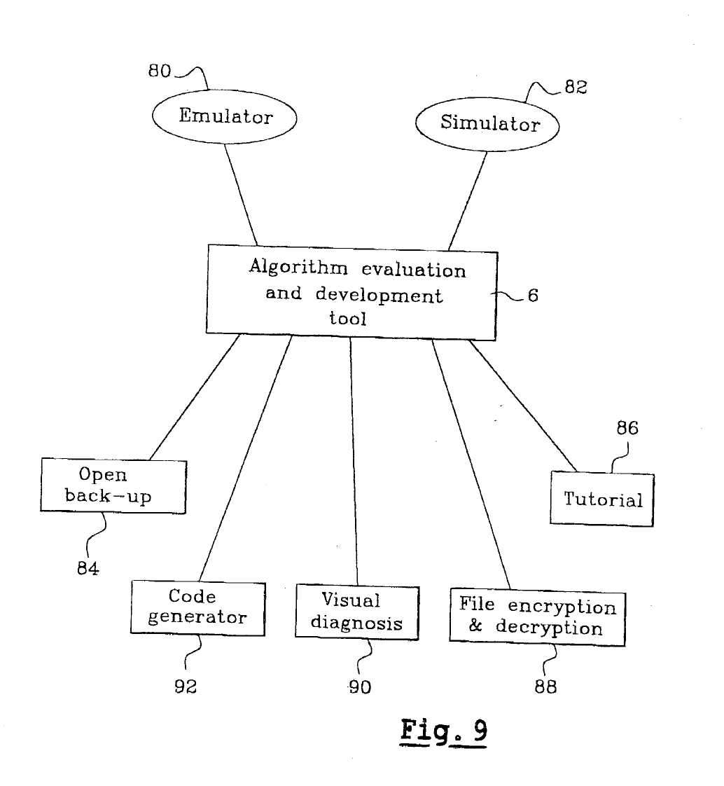

FIG. 9 is a theoretical diagram showing the different functions possible with the algorithm evaluation and development tool of FIG. 2.

The functional means implemented in a device according to the invention are described with reference to FIG. 2. This figure shows symbolically a computer such as a personal computer (PC) 2 associated to a software interface 4. The latter is formed by a set of programs and files accessible by the computer 2 such that the functional unit formed by the software interface and the computer forms an algorithm evaluation and development tool 6.

In the example, the set of programs and files comprises:

a graphics interface 8 for, among other things, driving the tool 8 as a whole interactively by means of a monitor 10, a keyboard 12 and a screen pointing device 14, such as a mouse or trackball (these means 10 to 14) are hereafter globally designated by the term man-machine interface 15);

a base function sequencing unit 16 (hereafter designated sequencing unit) for building and breaking down an algorithm, and in particular an encryption algorithm, through a concatenation (i.e. chained sequence) of base functions;

a unit 18 for executing an algorithm step by step (hereafter designated execution unit), for executing an algorithm successively through each of the base functions;

a unit 20 for analyzing results (hereafter designated analyzing unit) allowing to probe into the execution of the algorithm at the level of base functions; and

an executable program code generator 22 (hereafter designated code generator) for writing in an appropriate language an algorithm execution program entered and validated e.g. in source code or in assembler.

The different units mentioned above operate in tandem with the hardware of the computer 2, and in particular its calculation unit 24, in the form of a microprocessor, optionally with a co-processor (not shown) and its storage units. One of the storage units 26 serves in particular to store in the form of modules a library of base functions used by the different units of the computer interface 4. The exchange of data between the computer and the software interface 4 takes place through a set of internal buses generally designated by reference numeral 28.

A mode of operation of the algorithm evaluation and development tool 6 shall be described with reference to the flowchart of FIG. 3. The operation starts from step E1 of specifying the encryption algorithm. This step is analogous to the corresponding step of FIG. 1 and consists in establishing the specifics, or list of requirements, of the algorithm to build, such as the number of bits for the encryption, the structure required for the input and output data, the characteristics of the encryption key, the encryption calculations, etc.

The specification is entered by means of the graphics interface 8, which guides the user via the man-machine interface 15. As shown by block ES1 of FIG. 3, the graphics interface 8 is active up to the validation of the algorithm, so allowing the user to follow through the complete procedure graphically and to interact at any moment in real time.

Next is established the mathematical expression of the encryption algorithm (step E2), taking into account the specification established at the preceding step. Step E2 calls into play the base function modules in the aforementioned storage zone 26. For a given base function, there can be several input data with several output parameters. In the example, these modules are presented in graphic form on a screen menu. They can then be designated and arranged to create chained links so as to construct the desired algorithm from elementary operations (step E3). It will be appreciated that the aforementioned steps E2 and E4 are intermeshed and that their separation is arbitrary. The output data of one module then serve as input data for the succeeding module, and so on. The operations performed by the different base functions are of two types:

of low level: basic arithmetic operations, such as addition, multiplication, division, subtraction, and all that is a cryptographic algorithm; and

of higher level, i.e. operations for executing a part of the algorithm, for example Rivest, Adleman and Shamir (RSA), Secure Hash Algorithm (SHA), Digital Signature Algorithm (DSA) types of calculation, and others.

Starting from these base functions high level functions and protocols, i.e. high-level algorithms are established. For each base function, several possible input parameters and output parameters are taken into account. Thus, each base function keeps to a given user specification established at step E1. These parameters must be all the more controlled as they are numerous at the input or output.

The procedure then proceeds with the step of checking against the established specification on the one hand the utilization validity of each of the modules, and on the other hand the overall validity of the entirety of these concatenated modules (step E6). This step brings into play the execution unit 18, which scrutinizes the input and output data of each implemented module by checking the step-by-step execution and the step-by-step sequencing of the base functions, this checking being performed with respect to the specification. The checking in question can be based on the form of the data. For instance, if an input or output data of a given module must be comprised between the values of 0 and 32, the execution unit 18 shall ensure that it does not exceed that latter value or that it does not contain a negative value.

The execution unit thus performs a check on the nature of the parameters established for each of the modules. Indeed, in some algorithms, it is required that an input parameter be of a specific type, for example an element of the set of prime numbers, or that it contain a preestablished number of bits (case of an external criterion).

By checking in this way the execution of the algorithm at each stage of a succession of base functions, it can be ascertained that the algorithm to be developed does indeed correspond to the specification. Thus, these software means allow a detailed check of input parameters and input data. This checking is performed graphically and visually via the graphic interface 8. In particular, there is displayed what functions and what does not function within the algorithm.

Next is performed a diagnosis of the operations (step E8). Any errors detected and their context are displayed on the monitor 10. From this precise information, the user can identify the module(s) involved and act appropriately to correct the algorithm, or possibly the specification (step E10 and return loop R2).

If, or when, no error appears in the results analysis, the algorithm is validated (step E12).

By contrast with the classical approach of FIG. 1, the tool 6 in accordance with the invention does not need to create a test program. It simply performs tests with data, and indicates if the results comply or not with the specification. The number of test data to apply is determined arbitrarily by the operator as a function of the nature of the base functions to be tested and the imposed reliability criteria.

Note that in accordance with the invention, the algorithm to be developed does not need to be transformed into source code in order to be evaluated. The algorithm is simply written down on paper—or directly via the software interface—and the operator recreates the chaining of functions expressed by that algorithm through the tool. This tool indicates whether the chaining of the base functions complies with the specification. In other words, there is no need to create an executable program, nor a test program. Yet one is informed, simply by writing the algorithm and reproducing it via that software tool, whether the algorithm is correct and valid with respect to the specification.

According to an optional aspect of the invention, the tool 6 also implements a code generator 22 to create an executable code if, or when, the algorithm is valid (step E14). One is then sure that the executable code shall operate in accordance with the specification for the base functions.

Time savings are thus achieved by the computer-aided program creation and by the elimination of the entire test phase based on a test program specifically adapted to the algorithm's executable program.

Indeed, the algorithm is validated before it is even transformed into a program, by a mathematical simulation with a control of input data and output data, this validation being effected at each elementary algorithmic group within the algorithm. In other words, all the input and output parameters are checked at each step of the algorithm, which in fact corresponds to calling up a base function. This makes it possible achieve a very detailed check of the algorithm without having to create any program.

It is possible to use the tool 6 only for validating an algorithm without creating an executable code, in which case the procedure is terminated immediately after the validation (loop B1).

There shall now be described with reference to FIGS. 4 to 8 examples of screen display pages on a monitor 10, which allow an interactive control of the entire procedure just described for elaborating and validating an algorithm. These screen pages are managed by a graphic interface 8 belonging to the software interface 4.

FIG. 4 shows a page for accessing the library of base function modules 40 stored in the computer 2. These modules are displayed in the form of tabs on which it is possible to “click” with the designation device 14 to bring them into the foreground. In the example, the currently activated module is the one allowing access to the functions linked to prime numbers. There then appears the choice of parameter-setting connected to that module in the form of pushbuttons 42 accessible by the pointing device: initialization of a prime number generator, choice of candidate (base or RSA type), starting the test function, and others.

Other accessible modules correspond to low level functions (“Montgomery” constants, base functions, modulo functions, . . . and to higher level functions (SHA-1, RSA, DSA, . . .)

The user can thus call up different modules and configure them in accordance with the specification for the algorithm.

A menu header designated “link” 44 allows the user to link together the different modules to construct an algorithm.

FIG. 5 depicts an active screen just before the tool 6 executes an algorithm. It comprises a series of windows 50 of one single line. Each of these windows indicates in short a respective zone of the memory located in a piece of equipment for which the simulation is carried out, for example in registers of a chip card. In the example, these zones correspond to registers (A_reg, B_reg, S_reg, N_reg, J0_reg) linked to memory zones assigned to an arithmetic coprocessor, i.e. a hardware entity for accelerating cryptographic calculations on chip cards.

Some variables stored in random access memory space and used by the chip card are shown in a window designated “RAM Variables” 52.

An indication of the number of bits which certain calculation input variables must occupy is displayed on a window designated “mode” 54.

Different values that come into play in the calculation (e.g. intermediate results) are presented in respective windows designated by figure reference 56.

FIG. 6 is a view of the active screen shown in FIG. 5 at a later stage during the calculation. It can be observed that the contents of the registers 50 and variables 52 that were initially set to 0 now display non-zero values which reflect the status of the execution of the algorithm in the different registers of the simulated device.

FIG. 7 shows a window 70 displaying in detail the contents of one of the registers (B_Reg), this content being shown in condensed form by the window 50 of FIG. 1. These detailed windows 70 can be displayed by clicking on the designation of the relevant register appearing on the screen page of FIG. 5.

FIG. 8 shows a report after analyzing the execution of a module, with an indication of errors and their origin if they occur.

The algorithm evaluation and development tool 6 can be conceived as a multipurpose means for carrying different tasks linked with the elaboration of an algorithm and its setting into the form of an executable code.

The multipurpose nature of the tool is illustrated graphically by FIG. 9, which depicts the tool 6 and the different functions it can provide, either separately or as a set of functions. For instance, the tool 6 can be used as:

an emulator 80, i.e. a hardware and software means for connecting to a hardware emulation system, which reproduces the operation of a product (e.g. a chip card) in its entirety. In this case, the tool 6 serves to test a code to be recorded in the product to validate it at a final validation stage. In such an application, the product calls upon the tool 6 when an algorithmic calculation (e.g. a cryptographic calculation) is required. The tool will then perform that calculation and place the data corresponding to the result into the product;

a simulator 82, where the tool reproduces the operation of a chip in its entirety, but only in terms of software;

an apparatus 84 for storing input data and opening files, the tool then serving as a data library for files and base function modules, making it possible to make back-ups and recreate concatenations of functions;

assistance means 86 where it uses the different functions provided by the help files and other teaching software for assisting in rapidly acquiring a working knowledge. It also allows connection to the user manual on chip or through a help line;

a file encryption and decryption apparatus 88, allowing insertion of a file to be encrypted and delivery of the latter in encrypted form;

a visual diagnostic tool 90, i.e. the principal function such as described with reference to FIGS. 2 to 8; and

a code generator 92, for producing an executable code from an algorithm.

One of the applications of the invention is in encryption systems for chip cards. In this case, the chip card contains the above-described cryptographic base functions stored in registers of its memory zone, and which are called up by the software code. The card operator who wishes to implement encryption or decryption algorithmic means will then use these base functions in terms of elementary modules in accordance with a concatenation that is determined and validated by the tool 6. Note that these modules are difficult to handle and use in a classical approach, i.e. without the help of the tool.

More specifically, the tool 6 possesses all the encryption functions which are supplied by the cryptographic library carried on the chip card (or associated apparatus, such as a chip card reader). The operator can then construct his algorithm step by step, by successively calling up low-level functions. He enters via the interface 8 the input data of each function and by clicking on the buttons appearing on the screen pages, the tool gives him the result.

He can thus carry out its encryption/decryption step by step, the tool detecting the incorrect manipulations of functions and displaying error messages.

The developer can thus, without having written a single line of code, validate his chain sequencing of functions and, if he wishes, the tool can create the assembler code corresponding to his algorithm. This tool thus makes it possible to shorten the development, test and validation phases.

Its main functionality is to enable a cryptographic algorithm to be validated in a visual manner and to automatically generate the “on board” code.

The tool according to the invention thus allows the developer to call up the base function modules in a correct way in order to establish a code which is valid and functional in all aspects.

1. Device (6) for the evaluation of algorithms, characterized in that it comprises:
means (8,15) for entering an algorithm and a specification imposed on that algorithm;
means (16) for presenting the algorithm as a concatenation of base functions, each implying at least one basic algorithmic function;
means (18) for checking parameters involved in the execution of the base functions by reference to said specification; and
means (20) for indicating an error, as the case arises, detected by the checking means.

2. Device according to claim 1, wherein the base functions present themselves in the form of respective modules, of which at least some are modules for executing low level operations (for example simple arithmetic operations).

3. Device according to claim 2, wherein some modules are modules for executing higher level operations, for example Secure Hash Algorithm (SHA), or Digital Signature Algorithm (DSA) type operations, etc.

4. Device according to any one of claims 1 to 3, further comprising a graphics interface (8) allowing overall access to the functions offered.

5. Device according to any one of claims 1 to 4, presenting in graphic form input and output parameters of data relative to each base function implemented.

6. Device according to any one of claims 1 to 5, wherein said indicating means (20) present a diagnosis of an error, as the case arises, indicating the base function(s) involved in the error.

7. Device according to any one of claims 1 to 6, further comprising means for creating an executable software code corresponding to a validated algorithm.

8. Device according to any one of claims 1 to 7, wherein said algorithm pertains to encryption and/or decryption calculations.

9. Device according to any one of claims 1 to 8, configured to operate with a hardware type of emulator, said device having a connection to an equipment emulation system, such as an integrated circuit card (smart card).

10. Device according to any one of claims 1 to 9, configured to operate with a simulator, said device having a connection to an equipment simulator, such an integrated circuit card (smart card).

11. Device according to any one of claims 1 to 10, functionally integrated to a PC type computer (2).

12. Use of a device according to any one of claims 1 to 11 for the construction of an algorithm exploitable from a library of cryptographic base modules carried in an integrated circuit, such as an integrated circuit card (smart card).

13. Method of evaluating algorithms comprising a step (E1) of establishing a specification for said algorithm and a step (E2) of establishing an algorithm having to conform to said specification;
characterized in that it comprises the steps of:
presenting said algorithm as a concatenation of base functions, each implying at least one base algorithmic function (E4);
checking parameters involved in the execution of said base functions by reference to said specification (E6); and
indicating an error, as the case arises, detected during said checking step (E10).

14. Method according to claim 13, wherein the base functions present themselves in the form of respective modules, of which at least some are modules for executing low level operations (for example simple arithmetic operations).

15. Method according to claim 14, wherein some modules are modules for executing higher level operations, for example Secure Hash Algorithm (SHA), or Digital Signature Algorithm (DSA) type operations, etc.

16. Method according to any one of claims 13 to 15, allowing overall control on the method steps by an interactive graphic interface (8).

17. Method according to any one of claims 13 to 16, wherein input and output parameters of data relative to each base function implemented are presented in graphic form.

18. Method according to any one of claims 13 to 17, wherein during the indicating step (E10), there is presented a diagnosis of errors arising, indicating the base function(s) involved in the error.

19. Method according to any one of claims 13 to 18, comprising a step (E14) of creating an executable software code corresponding to an algorithm, once the said algorithm has been validated at the checking step (E10).

20. Method according to any one of claims 13 to 19, wherein said algorithm pertains to encryption and/or decryption calculations.
